(19) United States
(12) Patent Application Publication
(10) Pub. No.: US 2008/0285648 A1
(43) Pub. Date: Nov. 20, 2008

(54) Efficient Video Decoding Accelerator

(76) Inventor: Geraud Plagne, Nanterre (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 11/912,007

(22) PCT Filed: Apr. 14, 2006
(86) PCT No.: PCT/IB2006/051175

§ 371 Date: Jun. 4, 2008

(30) Foreign Application Priority Data
Apr. 22, 2005 (EP) 05300310.9

(51) Int. Cl. H04N 7/32

(52) U.S. Cl. 375/240.12; 375/E07.243

(57) ABSTRACT

The present invention relates to a decoding apparatus and method for decoding compressed video data having a plurality of video frames with a plurality of blocks, wherein the video frames are split in a first predetermined direction into at least two stripes whose width does not exceed a hardware prediction line size. Then, coefficient prediction is performed on one of the at least two stripes to provide a predictor in a second predetermined direction for at least one other of the at least two stripes, the second predetermined direction being perpendicular to the first predetermined direction. Additionally, fake blocks are generated to be inserted into the at least one other of said at least two stripes in order to initialize prediction in the second predetermined direction. Thereby, hardware accelerators with fixed processing width can be used in a more flexible manner.

The present invention relates to a decoder apparatus and decoding method for decoding compressed video data having a plurality of video frames with a plurality of blocks.

A widely known standard for video decoding, for instance, is MPEG, which is an abbreviation of “Moving Picture Experts Group”. Basically, MPEG is the name of a family of standards used for coding audio-visual information in a digital compressed format. Established in 1988, the group has produced MPEG-1, the standard on which such products as Video CD and MP3 are based, MPEG-2, the standard on which such products as Digital Television set top boxes and digital versatile disc (DVD) are based, MPEG-4, which is the standard for multimedia for the fixed and the mobile web. MPEG-4 is described in the standard ISO/IEC 14496-2001: CODING OF AUDIO-VISUAL OBJECTS.

Unlike MPEG-1 and MPEG-2, designed and, at least in the first phase, implemented as traditional hardware solutions, MPEG-4 was conceived as a standard whose implementation could be software. This explains why part 5 of the corresponding ISO/IEC 14496 standard contains a reference software implementation of the standard.

An MPEG video data stream contains pictures e.g. in PAL (phase alternating line) resolution, where a single picture or picture comprises 720 pixels in width and 576 pixels in height with a picture frequency of 25 Hz. That is, there is a time slot of 40 ms for transmission of this single picture. It is noted that both other picture sizes are also possible, e.g. for NTSC, as well as other picture frequencies, e.g. 30 Hz. Further, in MPEG each picture is split into several blocks for encoding. For this purpose, a block may comprise 8×8 pixels; also other sizes, for instance, 16×16 or 4×4 or even non squarish ones like 16×8 may be possible. Accordingly, a picture of 720×576 pixels comprises 6480 8×8 blocks. Using the YUV color space, for each 8×8 pixel block usually 64 Y-values (one for each pixel), but only 32 U-values and only 32 V-values are stored. This coding is known as the 4:2:2 scheme, which results in a total of 64+32+32=128 Byte for 64 pixels instead of 192 Byte in RGB-format. Thus, encoding in 4:2:2-scheme results in a total amount of 12960 blocks to encode a picture. It is to be noted that besides the 4:2:2 scheme there are other schemes possible, e.g. 4:4:4 or 4:2:0.

For digitalization, each of the three signal components (YUV) are divided into 8×8 pixel blocks and transformed from the spatial domain into the frequency domain by application of the discrete cosine transformation (DCT). The DCT splits each 8×8 pixel block into respective frequency components represented by an 8×8 DCT coefficients matrix. In the frequency domain, the larger DCT coefficient values are generally concentrated at the lower frequency components, which are located in the upper left area of the matrix. The lower frequency components include also the zero frequency DCT coefficient, which is also called the direct current (DC) component of the respective image block. The higher frequency components tend to have DCT coefficients of zero or nearly zero amplitude values. The highest frequency component is located in the lower left corner of the DCT matrix. Shortly, the lower right area of the DCT matrix represents the tiny details of the respective image block. This aspect is also considered in the quantization of the DCT coefficients, a further step in the encoding process, by the quantization matrix. Finally, each DCT matrix comprising 64 quantized DCT coefficients has to be converted from the matrix arrangement into an array. This conversion may be done by a zigzag run through the DCT matrix starting at the upper left corner, i.e. the DC DCT coefficient, down to the lower right corner, i.e. the highest DCT frequency coefficient. This conversion results in an array of quantized DCT coefficients. Finally, the array is lossless encoded, firstly by a run length (RL) code and by an entropy code, e.g. a Huffman encoder or variable length code (VLC).

The block-wise encoded picture data are arranged according to the respective MPEG standard. Finally, knowing the specific format of such MPEG bit-stream enables a receiving device to decode the transported visual information. Shortly, from the DCT coefficients of each image block by application of the inverse Discrete Cosine Transformation (iDCT) each single image block can be reconstructed.

Mobile phones now offer a wide variety of sophisticated applications in addition to voice communication, including games and moving-image distribution. However, with the higher communication speed of third generation (3G) mobile phones, data transfer speed becomes higher and further expansion is expected in such application areas as Videophones, and there is a demand for processors with faster image processing performance. At the same time, there has been a remarkable increase in the pixel count of cameras built into mobile phones, and the trend is expected to increase display sizes, bringing a need for processors capable of handling this display size.

In response to such needs, MPEG-4 hardware accelerators with increased image processing speed and enhanced functions such as camera interfaces have been developed. MPEG-4 video decoders on 3G mobile platforms more and more make use of such hardware accelerators which serve to enhance encoding/decoding processing capabilities for high-speed MPEG-4 processing. Not only is lower power consumption achieved through hardware processing, but also the CPU (Central Processing Unit) load for processing has been reduced considerably. This makes it possible to implement high-performance, low-power-consumption systems incorporating moving-picture playback, Videophone, and similar sophisticated functions.

The hardware and/or software partitioning is key for the performance and/or cost of the final product, but also for enabling later software upgrades. One issue with integrated hardware accelerators (e.g. implemented as Application Specific Integrated Circuit (ASIC)) is the lack of flexibility, especially regarding their internal memory organization.

Improvements in performance of intra coding have been obtained by predicting the DC coefficient of the DCT blocks by using previously reconstructed DC coefficients. During intra coding of a macroblock or VOP (video object plane), only information from that macroblock or VOP is used. The VOP corresponds to an instance of a video object at a given time.

Further improvements have been obtained in MPEG-4 by predicting AC coefficients as well. A DC coefficient is a DCT coefficient for which the frequency is zero in both dimensions. An AC coefficient is a DCT coefficient for which the frequency in one or both dimensions is non-zero. AC/DC prediction reduces the number of bits required for encoding an intra frame by estimating DC and/or AC values from iDCT blocks.

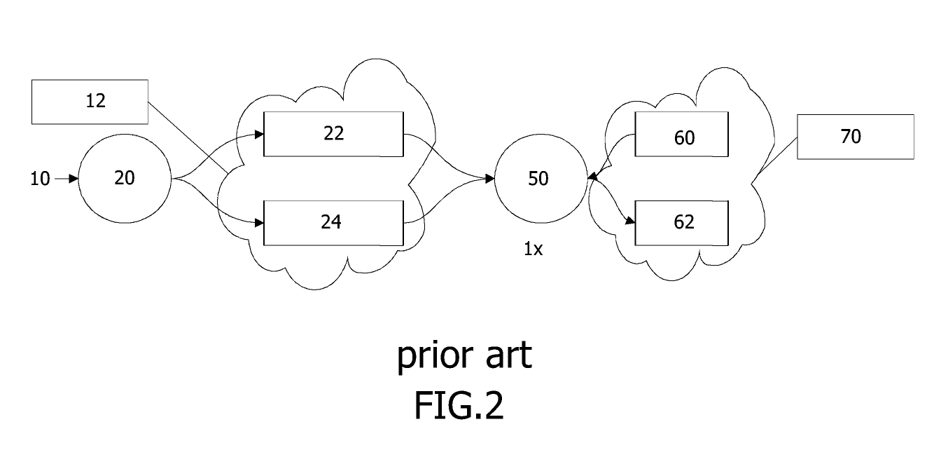

FIG. 2 shows a schematic flow diagram of a conventional decoding dataflow, where the software produces one dataset which is run all at a time by a hardware accelerator. An elementary MPEG-4 stream is read by a decoder software 20 which produces a single dataset 12 comprising runlength-coded (RL-coded) and quantized AC/DC coefficients 22 and a micro program 24 which are used by a decoder hardware accelerator 50 to execute a decoding process in a single run. The accelerated hardware decoding process is based on a single frame area 70 comprising a reference frame 60 and a decoded frame 62, wherein ping-pong frame buffers may be used for temporal prediction.

In the case of MPEG-4 video, implementing coefficient prediction as a hardware block in a hardware accelerator requires that a line of predictors, consisting of both DC and AC coefficients, is kept and updated in an internal memory (see §7.4.3 of the above standard ISO/IEC 14496-2001). The size of this line, which is used for vertical prediction, is fixed for cost reasons by the product requirements known at design time. For instance, a requirement of CIF (352×288) video decoding results in a line of exactly 22 macro-block predictors (i.e. 352 pixels), not more. In this configuration, it is not possible to let the hardware perform the coefficient prediction for e.g. VGA (640×480) clips, where a line of 40 macro-blocks would be required.

One alternative is to do the whole coefficient prediction in software, but this requires that the hardware design is such that this processing step may be skipped or inhibited, and there is enough headroom in the system to allow a dramatic increasing of the CPU load.

It is therefore an objective of the present invention to provide an improved coefficient prediction option, by means of which the above limitations faced in connection with hardware accelerators can be removed.

This object is achieved by a video decoder apparatus according to claim 1 and by a decoding method according to claim 13.

Accordingly, the initially described limitations faced in connection with hardware accelerators can be bypassed by splitting the video frames into stripes of suitable width and performing prediction of coefficients based on said stripes.

The first direction may correspond to the vertical direction of the video frame and the second direction may corresponds to the horizontal direction of the video frame, and vice versa. Thereby, the splitting direction is adapted to the prediction directions, so that AC/DC prediction costs can be minimized.

The generating means may be adapted to insert fake blocks as a first column into the at least one other of the at least two stripes. This serves to further reduce the amount of predictions necessary.

Furthermore, the splitting means may be adapted to produce a respective dataset with a respective micro program for each of the at least two stripes, the respective dataset and micro program being used for coefficient prediction by the prediction means. The prediction means may comprise a hardware accelerator and the splitting means may be implemented by a decoder software. Thus, the limitations introduced by the fixed processing width of the prediction means, e.g. hardware accelerator, can be alleviated or bypassed by (re-)introducing some minimum amount of software operation. Also, the generating means may be implemented by the decoder software.

The prediction means may be adapted to process the at least two stripes sequentially. Additionally, it may be adapted to perform a partial prediction. The at least two stripes may be overlapped at a predetermined overlapping area where the generated faked blocks are inserted. The generating means may then be adapted to generate the fake blocks by performing a reverse prediction based on predictors obtained from the prediction means for the one of the at least two stripes.

The software operation portion of the proposed improved decoding mechanism or procedure can be implemented as a computer program product comprising code means adapted to produce the splitting and generating steps of method claim 13 when run on a computer device. The computer program product may be stored a computer-readable medium.

Advantageously, the decoder apparatus and the decoding method according to the present invention can be incorporated in a system comprising a sender and a receiver for transmission of a bit-stream that contains video data from said sender to said receiver over a wireless connection. The receiver may be implemented in or connected to a wireless monitor for displaying the transmitted video data. The sender may be implemented in or connected to a source for an input bit-stream containing the video data, e.g. a digital video source may be a DVD player or a connection to a video provider over a cable net, a satellite connection or alike. The sender may also be connected to camera, e.g. a surveillance camera, delivering a video bit-stream containing video data generated by said camera. Finally yet importantly, when the decoding procedure according to the preferred embodiment is used on the receiver side any device compatible to the respective used standard for the data stream format can be incorporated into the system.

The present invention will now be described based on a preferred embodiment with reference to the accompanying drawing figures in which:

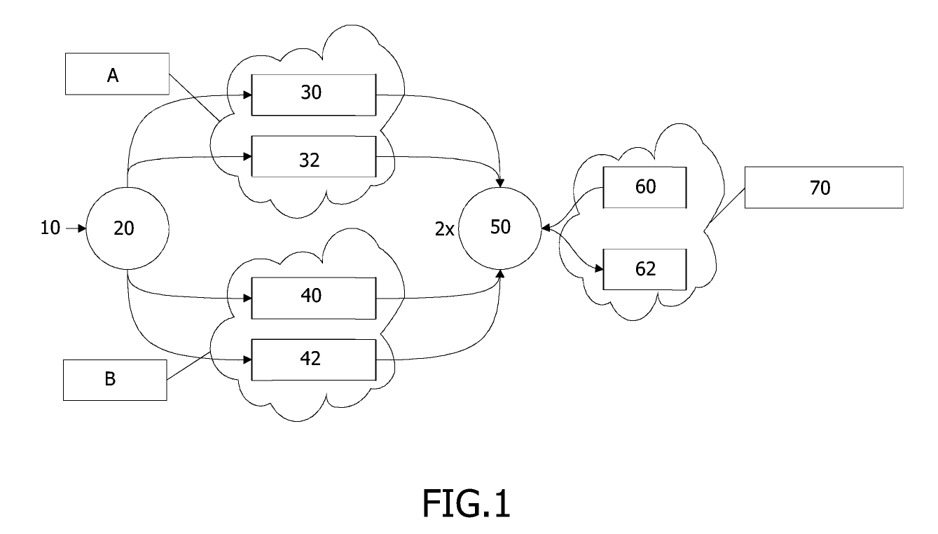

FIG. 1 shows a block diagram showing a decoding operation according to a preferred embodiment;

FIG. 2 shows a block diagram showing a conventional decoding operation;

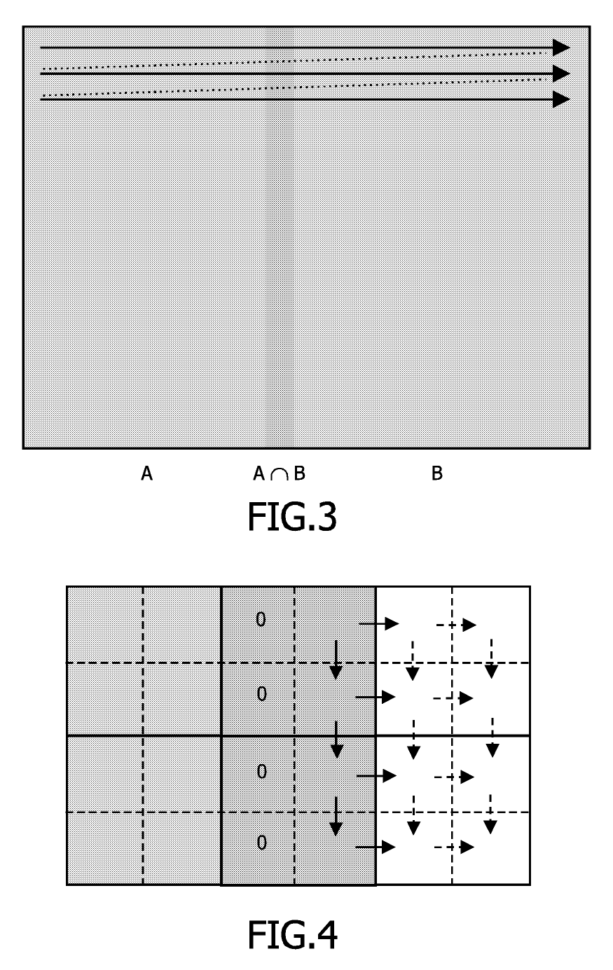

FIG. 3 shows a schematic diagram of a video frame with a frame split according to the preferred embodiment; and

FIG. 4 shows a schematic diagram of a frame portion with possible prediction directions according to the preferred embodiment.

In the following, the preferred embodiment of the present invention will be described in connection with a coefficient prediction operation for a video data stream, e.g., an MPEG-4 elementary stream. The video data stream may have been delivered from a video source, e.g. a DVD-player or a TV set top box, to a display device for display of the image information of the video data stream, e.g. a high-resolution video LCD or plasma monitor. The source for a video/audio data for such a set top box, for instance, may be a digital video broadcast (DVB) signal delivered terrestrial (DVB-T) or via satellite (DVB-S). Other sources may relate to network streaming and download-and-play applications.

Depending on the type of the macroblock, motion vector information and other side information is encoded with the compressed prediction error in each macroblock. The motion vectors are differenced with respect to a prediction value and coded using variable length codes. The maximum length of the motion vectors allowed is decided at the encoder. It is the responsibility of the encoder to calculate appropriate motion vectors.

According to the preferred embodiment, an improved prediction process for decoding of AC/DC coefficients is proposed. In general, prediction refers to the use of a predictor to provide an estimate of the sample value or data element currently being decoded. A predictor is a linear combination of previously decoded sample values or data elements. Forward prediction defines a prediction from the past reference VOP, while backward prediction defines a prediction from the future reference VOP.

Spatial prediction is a prediction derived from a decoded frame of the reference layer decoder used in spatial scalability which is a type of scalability where an enhancement layer also uses predictions from sample data derived from a lower layer without using motion vectors. The layers can have different VOP sizes or VOP rates.

The prediction of DC and AC coefficients is carried out for intra macroblocks (I-MB s).

An adaptive selection of the DC and AC prediction direction may be based on a comparison of the horizontal and vertical DC gradients around the block to be decoded. In the following example case, three blocks surrounding a current block ‘X’ to be decoded are designated ‘A’, ‘B’ and ‘C’, respectively, wherein block A corresponds the left block, block B to the above-left block, and block C to the block immediately above. Then, the inverse quantized DC values of the previously decoded blocks are used to determine the direction of the DC and AC prediction. In particular, if the absolute value of the difference between the inverse quantized DC values of blocks A and B is less than the absolute value of the difference between the inverse quantized DC values of blocks B and C, than prediction is based on block C. Otherwise, prediction is based on block A.

If any of the blocks A, B or C are outside of the VOP boundary, or the video packet boundary, or they do not belong to an intra coded macroblock, their inverse quantized DC values are assumed to take a predefined value and are used to compute the prediction values.

An adaptive DC prediction method involves selection of either the inverse quantized DC value of an immediately previous block or that of the block immediately above it (in the previous row of blocks) depending on the prediction direction determined above. This process may be independently repeated for every block of a macroblock using the appropriate immediately horizontally adjacent block A and immediately vertically adjacent block C.

DC predictions are performed similarly for the luminance and each of the two chrominance components.

An adaptive AC coefficient prediction may be also used, where either coefficients from the first row or the first column of a previous coded block are used to predict the co-sited coefficients of the current block. On a block basis, the best direction (from among horizontal and vertical directions) for DC coefficient prediction is also used to select the direction for AC coefficients prediction. Thus, within a macroblock, for example, it becomes possible to predict each block independently from either the horizontally adjacent previous block or the vertically adjacent previous block. The two-dimensional array of coefficients is inverse quantized to produce the reconstructed DCT coefficients. This process is essentially a multiplication by the quantizer step size. The quantizer step size is modified by two mechanisms. A weighting matrix is used to modify the step size within a block and a scale factor is used in order that the step size can be modified at the cost of only a few bits (as compared to encoding an entire new weighting matrix).

According to the preferred embodiment, flexibility of hardware acceleration of the above procedures is enhanced by vertically splitting video frames into stripes whose width does not exceed the hardware prediction line size, so that the hardware prediction is operational. Then, a light-weight (partial) prediction is performed by software on the leftmost stripe(s) to provide suitable horizontal predictors to the rightmost stripe(s). Thereafter, fake macro-blocks to be inserted as a first column in rightmost stripe(s) are forged in order to initialize the horizontal prediction.

The following description is based on an example of a vertical frame split into two vertical stripes. However, the proposed flexible prediction mechanism would be identical for three or more stripes.

FIG. 1 depicts a schematic flow diagram of a decoding dataflow where the proposed frame splitting approach according to the preferred embodiment is implemented. Contrary to the conventional approach of FIG. 1, the decoder software 20 now produces two datasets A and B with respective RL-coded and quantized AC/DC coefficients 30, 40 and two respective micro-programs 32, 42 that each cover a respective vertical stripe of a current video frame. The two micro-programs 32, 42 are run sequentially (i.e. in two hardware runs) by the hardware accelerator 50 so as to eventually cover the whole destination frame.

FIG. 3 shows a schematic diagram of a video frame with a frame split according to the preferred embodiment, wherein respective positions of the frame areas of the datasets A and B are depicted. In particular, FIG. 3 represents a video frame whose width exceeds the hardware capabilities of the hardware accelerator 50. Each video frame contains lines of spatial information of a video signal. For progressive video, these lines contain samples starting from one time instant and continuing through successive lines to the bottom of the frame. The frame rate defines the rate at which frames are output from the composition process.

In the example of the preferred embodiment, the video frame is split into the two areas A and B that will be processed sequentially by the hardware accelerator 50, i.e. B first, and then A. The role of the stripe overlap (A∩B) area is explained later.

On one hand, the proposed vertical split solves the issue of vertical prediction. On the other hand it breaks the horizontal prediction at the inter-stripe borders.

Consequently, the leftmost stripe excepted, each macro-block line of each vertical stripe needs to have the horizontal prediction initialized. Therefore, the horizontal prediction must be done in software for the area A.

A light-weight or partial prediction can be performed as follows. As there is no vertical interaction between areas A and B, the only AC and DC horizontal predictors need to be computed in the A area. For AC coefficients, this means that the coefficients of the first column of the DCT matrix are enough, and the first line processing cost is saved. Hence, in the B area, no prediction is required at all. In total up to 60 to 70% of the AC/DC prediction cost can thereby be saved.

Furthermore, initialization macroblocks can be forged as follows.

In order to initialize the horizontal AC/DC prediction in the B area, a macro-block is forged and defined as the start of each macro-block line in the B area. This mechanism explains why A and B overlap. The forged macro-block column is the A∩B area. As this area is not part of the video sequence, it must be overwritten before display. This does not require an additional operation, provided that the B area is decoded before the A area.

FIG. 4 shows a schematic diagram of a frame portion with possible prediction directions according to the preferred embodiment. In particular, those possible prediction directions are shown that impact the leftmost eventually visible macro-block of the B area.

The dashed arrows depict the directions that fit inside the B area. The corresponding predictions are suitably performed by hardware, e.g. by the hardware accelerator 50, without software operation. Conversely, the black arrows are the directions that must be reverse-predicted by software, e.g. by the decoder software 20, to forge the A∩B area. Based on the obtained partial predictors, a reverse prediction gives the contents of the A∩B area.

In summary, during the proposed MPEG-4 decoding, the frame macro-blocks are scanned in left-right, top-down order as shown in FIG. 3. For each macro-block line, macroblocks are processed differently based on their position relatively to the stripes.

In the following table, the output of the software process is listed as a function of the processed macro-block.

| <Process> \ When decoding macro-block from <. . .> | A - A∩B | A∩B | B - A∩B |
|---|---|---|---|
| Basic | A | A | B |
| Light-weight AC/DC prediction | internal | internal | |
| Initialization macro-block forging | | B | |

In the above table, the ‘Basic’ process consists of the MPEG-4 standard software decoding, e.g., bitstream parsing, variable-length decoding and motion decoding.

In summary, a decoding apparatus and method have been described for decoding compressed video data having a plurality of video frames with a plurality of blocks, wherein the video frames are split in a first predetermined direction into at least two stripes whose width does not exceed a hardware prediction line size. Then, coefficient prediction is performed on one of the at least two stripes to provide a predictor in a second predetermined direction for at least one other of the at least two stripes, the second predetermined direction being perpendicular to the first predetermined direction. Additionally, fake blocks are generated to be inserted into the at least one other of said at least two stripes in order to initialize prediction in the second predetermined direction. Thereby, hardware accelerators with fixed processing width can be used in a more flexible manner.

It is to be noted that the description of the invention with regard to MPEG video data shall not be seen as limitation to the invention. Basically, the inventive principle of the present invention may be applied to any decoding of video data requiring coefficient prediction. Specifically, the invention can be applied to any system using the so-called Monet MPEG-4 Video Decoder IP, as used for example in mobile communications chips. Moreover, the video frame can be split into more than two stripes which not necessarily have to be directed vertically. Splitting in the horizontal direction may as well be a feasible solution, provided the decoding hardware and/or software is suitably adapted. The insertion of the generated fake blocks may be done at any suitable location, provided they can be used as a suitable starting point to initialize remaining predictions.

Finally but yet importantly, it is noted that the term “comprising” when used in the specification including the claims is intended to specify the presence of stated features, means, steps or components, but does not exclude the presence or addition of one or more other features, means, steps, components or groups thereof. Furthermore, the word “a” or “an” preceding an element in a claim does not exclude the presence of a plurality of such elements. Moreover, any reference sign do not limit the scope of the claims. The invention can be implemented by means of both hardware and software, and several “means” may be represented by the same item or hardware.

1. A decoder apparatus for decoding compressed video data having a plurality of video frames with a plurality of blocks, said decoder apparatus comprising:
a) splitting means for splitting said video frames in a first predetermined direction into at least two stripes whose width does not exceed a hardware prediction line size of said decoder apparatus;
b) prediction means for performing a coefficient prediction on one of said at least two stripes to provide a predictor in a second predetermined direction for at least one other of said at least two stripes, said second predetermined direction being perpendicular to said first predetermined direction; and
c) generating means for generating fake blocks to be inserted into said at least one other of said at least two stripes.

2. A decoder apparatus according to claim 1, wherein said first direction corresponds to the vertical direction of said video frame and said second direction corresponds to the horizontal direction of said video frame.

3. A decoder apparatus according to claim 2, wherein said generating means is adapted to insert said fake blocks as a first column into said at least one other of said at least two stripes.

4. A decoder apparatus according to any one of the preceding claims, wherein said splitting means is adapted to produce a respective dataset with a respective micro program for each of said at least two stripes, said respective dataset and micro program being used for coefficient prediction by said prediction means.

5. A decoder apparatus according to claim 1, wherein said prediction means comprises a hardware accelerator and said splitting means is implemented by a decoder software.

6. A decoder apparatus according to claim 5, wherein said generating means is implemented by said decoder software.

7. A decoder apparatus according to claim 1, wherein said prediction means is adapted to process said at least two stripes sequentially.

8. A decoder apparatus according to claim 7, wherein said prediction means is adapted to perform a partial prediction.

9. A decoder apparatus according to claim 7, wherein said at least two stripes are overlapped at a predetermined overlapping area where said generated faked blocks are inserted.

10. A decoder apparatus according to claim 1, wherein said prediction means are adapted to predict coefficients of a discrete cosine transformation.

11. A decoder apparatus according to claim 1, wherein said generating means for is adapted to generate said fake blocks by performing a reverse prediction based on predictors obtained from said prediction means for said one of said at least two stripes.

12. A decoder apparatus according to claim 1, wherein said decoder apparatus is an MPEG-4 decoder.

13. A decoding method for decoding compressed video data having a plurality of video frames with a plurality of blocks, said decoding method comprising:
a) splitting said video frames in a first predetermined direction into at least two stripes whose width does not exceed a hardware prediction line size of said decoder apparatus;
b) performing a coefficient prediction on one of said at least two stripes to provide a predictor in a second predetermined direction for at least one other of said at least two stripes, said second predetermined direction being perpendicular to said first predetermined direction; and
c) generating fake blocks to be inserted into said at least one other of said at least two stripes in order to initialize prediction in said second predetermined direction.

14. A computer program product comprising code means adapted to produce steps a) and c) of method claim 13 when run on a computer device.

15. A computer readable medium on which a computer program product according to claim 14 is stored.
